(19) United States
(12) Patent Application Publication
(10) Pub. No.: US 2026/0319521 A1
(43) Pub. Date: Oct. 15, 2026

(54) Vision-guided drone-based method, device, and readable storage medium for subway inspection

(71) Applicant: Hangzhou City University, Hangzhou City (CN)

(72) Inventors: Fang WANG, Hangzhou City (CN); Chen LONG, Hangzhou City (CN); Wei HONG, Hangzhou City (CN); Chengjie JIANG, Hangzhou City (CN); Lei WANG, Hangzhou City (CN)

(73) Assignee: Hangzhou City University, Hangzhou City (CN)

(21) Appl. No.: 19/439,260

(22) Filed: Jan. 2, 2026

(30) Foreign Application Priority Data
Feb. 11, 2025 (CN) 2025101514049

(51) Int. Cl. G05D 1/689; B64U 20/80; B64U 101/26; G05D 105/80; G05D 107/50; G05D 109/25; G06T 7/00; G06T 7/246; G06T 7/593; G06T 7/73

(52) U.S. Cl. CPC G05D 1/689; G06T 7/0002; G06T 7/248; G06T 7/593; G06T 7/74; B64U 20/80; B64U 2101/26; G05D 2105/89; G05D 2107/50; G05D 2109/254; G06T 2207/10012; G06T 2207/10028; G06T 2207/10032; G06T 2207/30184; G06T 2207/30241

(57) ABSTRACT

The present invention discloses a vision-guided drone-based subway inspection method, a device, and a readable storage medium for subway inspection. The method includes: acquiring images of rails by using a stereo camera and marking data points on the acquired images; dividing the data points into left rail key points and right rail key points, and matching the rail key points in the left and right images; obtaining matching results of the rail key points in the left and right images, and calculating depth information of the rail key points in the images based on the camera's focal lengths and disparities between the left and right images; and calculating midpoints of the matched key points on both sides of the rails to extract reference paths for inspection of drones.

### CROSS-REFERENCE

This application claims the benefit of priority from China Patent Application No. CN 2025101514049 filed on Feb. 11 2025, the contents of which are hereby incorporated by reference in their entirety.

### TECHNICAL FIELD

The present invention relates to a vision-guided drone-based subway inspection method, a device, and a readable storage medium for subway inspection.

### BACKGROUND TECHNOLOGY

Subway inspection drones, as a new type of intelligent inspection tool, possess many advantages that traditional manual inspection methods cannot match. Drones can quickly and comprehensively fly and inspect every corner of the tunnel, including areas that are difficult for humans to reach (such as the top of the tunnel or narrow passages). They can quickly cover the entire tunnel section, saving significant time compared to traditional manual inspection methods. Subway inspections often involve dangerous environments, such as potential water accumulation, collapses, and poor ventilation within the tunnel. Traditional inspectors need to enter these dangerous areas, potentially facing health and safety risks. Drones, however, can be operated remotely, avoiding the need for personnel to enter complex or dangerous environments, thus ensuring personnel safety. Drones can also upload the collected data to a cloud platform or control center in real time, allowing operators to obtain inspection results and perform analysis immediately, enabling quick decision-making.

In existing technical solutions, some approaches utilize ground-based rail robots for inspection, controlling the robots to travel along rails and using their onboard sensors to detect the surrounding environment. While this method eliminates the need for odometry and reference path information, it lacks flexibility during inspection. When obstacles appear on the rail, the robot cannot perform the inspection, and the detection of the tunnel ceiling is not sufficiently clear. Other solutions involve pre-mapping using lidar, then marking a reference path. During actual inspection, the drone is controlled to fly along the preset path. This method requires offline marking of the reference path in the point cloud beforehand, and during actual inspection, relocalization or scene localization algorithms are needed to determine the drone's position within the previously collected point cloud. This requires high accuracy from the algorithms and is prone to cumulative errors during localization. Another approach involves deploying multiple UWB base stations for drone localization, but this method is costly and difficult to implement in long tunnels.

Patent CN115951704A discloses a method and equipment for drone-based subway inspection based on a BIM model (Building Information Model). The method includes: obtaining surveying data of various railway sections, and generating a subway inspection BIM model based on the surveying data; obtaining the size information of the inspection drone, and generating inspection path information corresponding to each railway section based on the size information and the subway inspection BIM model; sending the inspection plan information to the inspection control module of the inspection drone, and controlling the drone to perform inspections according to the preset path. This proposal requires evenly distributed monitoring points at various locations in the subway tunnel, and data surveying using total stations and monitoring positioning. The BIM model generated based on design drawings is then refined using the surveying data. This modeling process is cumbersome, requires expensive equipment, and is difficult to implement. Furthermore, in practical applications, the BIM model coordinate system needs to be aligned with the coordinate system used during drone inspection, increasing development difficulty.

Patent publication number CN109343548A discloses an inspection system for a subway tunnel inspection robot. The system includes: a robot body, a control unit, and a detection unit. The detection unit is mounted on the robot body; the control unit sends control commands to the robot body and the detection unit; the robot body moves along the rails inside the subway tunnel according to the control commands; and the detection unit, according to the control commands, detects the environment inside the subway tunnel while the robot body moves along the rails, and sends the detected data to the control unit, thus achieving automated inspection of the subway tunnel. This proposal uses a robot traveling on the rails for inspection. The advantage is that it does not require additional odometers and environmental information to control the robot to perform inspections in the center of the subway tunnel. However, it also limits the robot's flexibility during inspection. Because it travels on the rails, if there are obstacles on the rails, it may lead to danger and inspection failure. Furthermore, the method of traveling on the rails is far from the tunnel ceiling, making it difficult to detect data from the tunnel ceiling.

Patent CN117518158A discloses an equipment and method for full-section tunnel inspection based on drone-mounted ground-penetrating radars. This patent utilizes multiple millimeter-wave micro-communication base stations installed at equal intervals within the subway tunnel. During inspection, the drone's millimeter-wave radar module is positioned by these base stations, which also receive communication signals transmitted from the drone's flight control module via a wireless communication module. These base stations are connected to a tunnel scanning control center, allowing for accurate determination of the drone's current position even in areas with poor GPS signals, thus enabling the drone to follow a preset inspection path. While this method accurately determines the drone's position, it requires the deployment of multiple millimeter-wave micro-communication base stations inside the subway tunnel. If the tunnel is long and lacks a suitable deployment environment, the cost and implementation difficulty of this method increase significantly. Furthermore, maintenance is challenging; if one of the millimeter-wave micro-communication base stations malfunctions, the drone cannot be located near that location, leading to a system failure.

### SUMMARY OF THE INVENTION

The main objective of the present invention is to provide a vision-guided drone-based subway inspection method, a device, and a readable storage medium for subway inspection, so as to solve above technical problems.

In order to achieve the above objectives, the present invention provides a vision-guided drone-based subway inspection method, comprising following steps of:
using a stereo camera to acquire images of rails, and marking data points on acquired images;
dividing the data points into key points of left rails and key points of right rails, and matching rail key points in left and right images;
obtaining matching results of trajectory key points from the left and right images, and calculating image depth information of the trajectory key points based on camera's focal lengths and disparities between the left and right images; and;
calculating midpoints of matched key points on both sides of the rails to extract reference paths for the drone inspection.

In an embodiment, after the steps of using a stereo camera to acquire images of rails, and marking data points on acquired images, the vision-guided drone-based subway inspection method further comprises:
using prior information about rail dimensions to eliminate incorrectly detected key points and supplement missed key points, so that number of key points on left rails is equal to number of key points on right rails.

In an embodiment, the steps of using prior information about rail dimensions to eliminate incorrectly detected key points and supplement missed key points specifically comprises:
determining whether key points are incorrectly detected or missed by checking if distances between consecutive key points exceeds a maximum allowable distance or falls below a minimum allowable distance of sleepers.

In an embodiment, after the steps of obtaining matching results of trajectory key points from the left and right images, and calculating image depth information of the trajectory key points based on camera's focal lengths and disparities between the left and right images, the vision-guided drone-based subway inspection method further comprises:
transforming image data into real 3D space through camera's intrinsic and extrinsic matrices.

In an embodiment, after the steps of calculating midpoints of matched key points on both sides of the rails to extract reference paths for the drone inspection, the vision-guided drone-based subway inspection method further comprises:
obtaining drone's desired positions on the reference paths at a current time, and guiding the drones to perform inspection along the reference paths at the desired positions.

In an embodiment, the steps of obtaining drone's desired positions on the reference paths at a current time, and guiding the drones to perform inspection along the reference paths at the desired positions, comprise:
projecting the drones onto a trajectory plane, drawing circles with projected positions of the drones as centers and look-ahead distances as the radiuses, and using intersection points with the reference paths as optimal desired positions in a horizontal direction, thereby guiding the drones to perform inspection along the optimal desired positions on the reference paths.

Further, in order to achieve above objectives, the present invention further provides a vision-guided drone-based subway inspection device, comprising a memory, a processor, and a vision-guided drone-based subway inspection program stored in the memory and executable on the processor, wherein when the vision-guided drone-based subway inspection program is executed by the processor, the steps of the vision-guided drone-based subway inspection method mentioned above are performed.

Further, in order to achieve above objectives, the present invention further provides a computer-readable storage medium storing a vision-guided drone-based subway inspection program, wherein when the vision-guided drone-based subway inspection program is executed by a processor, the steps of the vision-guided drone-based subway inspection method mentioned above are performed.

The beneficial effects that can be achieved by the present invention are as follows: The embodiment of the present invention proposes a vision-guided drone-based subway inspection method, which uses a stereo camera to capture images of the rail and marks data points on the captured images; the data points are divided into left rail key points and right rail key points, and the rail key points in the left and right images are matched; after obtaining the matching results of the rail key points in the left and right images, the depth information of the rail key points in the image is calculated based on the camera's focal length and the disparity between the left and right images; the midpoint of the matched key points on both sides of the rail is calculated to extract the reference path for the drone inspection.

The present invention requires only a single stereo camera sensor to achieve fully automated inspection of the subway tunnel by a drone, significantly reducing inspection costs. Furthermore, it eliminates the need to pre-build a subway tunnel model or mark inspection paths. The system can automatically identify and rail the inspection path online, making the inspection process more intelligent and convenient.

### BRIEF DESCRIPTION OF THE DRAWINGS

FIG. 1 is a schematic diagram of the hardware operating environment involved in the embodiment of the present invention.

FIG. 2 is a flowchart of the vision-guided drone-based subway inspection method of the present invention.

FIG. 3 is a schematic diagram of rail marker point annotation in an embodiment of the present invention.

FIG. 4 is a schematic diagram of false detection of rail marker points in an embodiment of the present invention.

FIG. 5 is a schematic diagram of missed detection of rail marker points in an embodiment of the present invention.

FIG. 6 is a schematic diagram of the drone's pre-scanning range in an embodiment of the present invention.

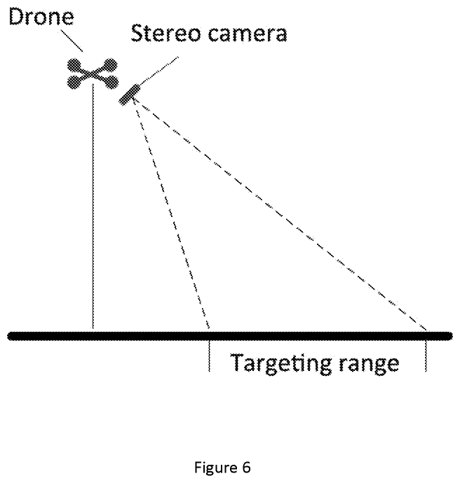

FIG. 7 is a schematic diagram of the drone's railing reference path in an embodiment of the present invention.

The realization of the objectives, functional features, and advantages of this invention will be further explained in conjunction with the embodiments and with reference to the accompanying drawings.

### SPECIFIC EMBODIMENTS

It should be understood that the specific embodiments described herein are merely for explaining the present invention and are not intended to limit the scope of the invention.

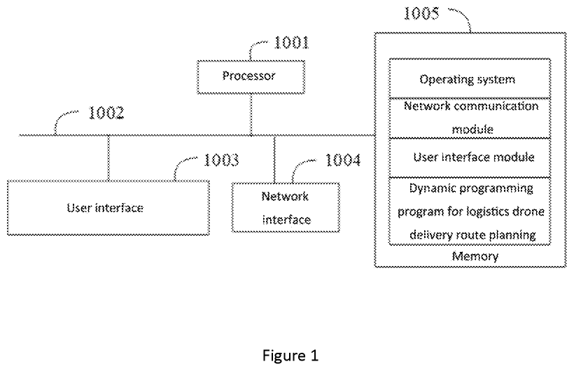

As shown in FIG. 1, FIG. 1 is a schematic diagram of the terminal structure of the hardware operating environment involved in an embodiment of the present invention.

The terminal device in this embodiment of the invention can be a PC, or a mobile terminal device with display capabilities such as a smartphone, tablet computer, e-book reader, MP3 (Moving Picture Experts Group Audio Layer III) player, MP4 (Moving Picture Experts Group Audio Layer IV) player, or portable computer.

As shown in FIG. 1, the terminal may include: a processor 1001, such as a CPU; a communication bus 1002; a user interface 1003; a network interface 1004; and a memory 1005. The communication bus 1002 is used to facilitate communication between these components. The user interface 1003 may include a display and an input unit such as a keyboard. Optionally, the user interface 1003 may also include standard wired and wireless interfaces. The network interface 1004 may optionally include standard wired and wireless interfaces (such as a Wi-Fi interface). The memory 1005 can be high-speed RAM memory or non-volatile memory, such as disk storage. Optionally, the memory 1005 can also be a storage device independent of the aforementioned processor 1001.

Optionally, the terminal may also include a camera, RF (Radio Frequency) circuitry, sensors, audio circuitry, a WiFi module, etc. The sensors may include light sensors, motion sensors, and other sensors. Specifically, the light sensors may include an ambient light sensor and a proximity sensor. The ambient light sensor can adjust the screen brightness based on the ambient light intensity, and the proximity sensor can turn off the screen and/or backlight when the mobile terminal is moved close to the ear. As a type of motion sensor, the accelerometer can detect the magnitude of acceleration in various directions (generally three axes). When stationary, it can detect the magnitude and direction of gravity, and can be used in applications that identify the mobile terminal's orientation (such as screen rotation, related games, magnetometer calibration), and vibration detection functions (such as pedometers, tapping), etc. Of course, the mobile terminal can also be configured with other sensors such as a gyroscope, barometer, hygrometer, thermometer, and infrared sensor, which will not be described in detail here.

Those skilled in the art will understand that the terminal structure shown in FIG. 1 does not constitute a limitation of the terminal, and may include more or fewer components than shown in the figure, or combine certain components, or have a different arrangement of components.

As shown in FIG. 1, the memory 1005, which is a computer storage medium, may include an operating system, a network communication module, a user interface module, and a vision-guided drone subway inspection program.

In the terminal shown in FIG. 1, the network interface 1004 is mainly used to connect to the backend server and perform data communication with the backend server; the user interface 1003 is mainly used to connect to the client (user end) and perform data communication with the client; and the processor 1001 can be used to call the vision-guided drone subway inspection program stored in the memory 1005 and perform the following operations: using a stereo camera to acquire images of rails, and marking data points on acquired images;
dividing the data points into key points of left rails and key points of right rails, and matching rail key points in left and right images;
obtaining matching results of trajectory key points from the left and right images, and calculating image depth information of the trajectory key points based on camera's focal lengths and disparities between the left and right images; and;
calculating midpoints of matched key points on both sides of the rails to extract reference paths for the drone inspection.

Furthermore, the processor 1001 can call the vision-guided drone subway inspection program stored in the memory 1005 and perform the following operations:
using prior information about rail dimensions to eliminate incorrectly detected key points and supplement missed key points, so that number of key points on left rails is equal to number of key points on right rails.

Furthermore, the processor 1001 can call the vision-guided drone subway inspection program stored in the memory 1005 and perform the following operations:
determining whether key points are incorrectly detected or missed by checking if distances between consecutive key points exceeds a maximum allowable distance or falls below a minimum allowable distance of sleepers.

Furthermore, the processor 1001 can call the vision-guided drone subway inspection program stored in the memory 1005 and perform the following operations: transforming image data into real 3D space through camera's intrinsic and extrinsic matrices.

Furthermore, the processor 1001 can call the vision-guided drone subway inspection program stored in the memory 1005 and perform the following operations:
obtaining drone's desired positions on the reference paths at a current time, and guiding the drones to perform inspection along the reference paths at the desired positions.

Furthermore, the processor 1001 can call the vision-guided drone subway inspection program stored in the memory 1005 and perform the following operations:
projecting the drones onto a trajectory plane, drawing circles with projected positions of the drones as centers and look-ahead distances as the radiuses, and using intersection points with the reference paths as optimal desired positions in a horizontal direction, thereby guiding the drones to perform inspection along the optimal desired positions on the reference paths.

The specific embodiments of the data storage device used in this invention are essentially the same as the embodiments of the vision-guided drone-based subway inspection method described below, and therefore will not be described in detail here.

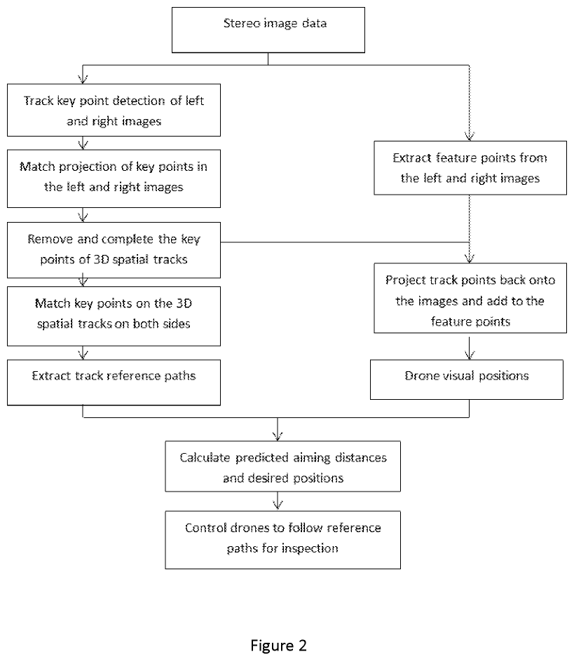

Please refer to FIG. 2, a first embodiment of the present invention provides a vision-guided drone-based subway inspection method, comprising following steps of:
using a stereo camera to acquire images of rails, and marking data points on acquired images;
dividing the data points into key points of left rails and key points of right rails, and matching rail key points in left and right images;
obtaining matching results of trajectory key points from the left and right images, and calculating image depth information of the trajectory key points based on camera's focal lengths and disparities between the left and right images; and;
calculating midpoints of matched key points on both sides of the rails to extract reference paths for the drone inspection.

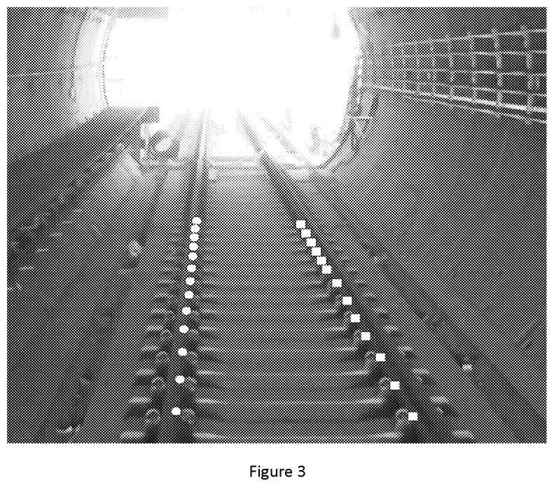

Please refer to FIG. 3, a key point detection model based on deep learning is used to detect rail key points in the acquired stereo images. When annotating the data, the rail key points are defined as the intersection points of the rails and sleepers, divided into two categories: left rail key points and right rail key points, with the left and right directions based on the shooting direction. Red markers represent the left rail key points, and green markers represent the right rail key points. Optionally, the key point detection model can use a spatial embedding model. The input image data is processed through a backbone network to output three feature maps: a confidence feature map, an offset feature map (x and y), and an embedding vector branch. The indices of points on the feature map with confidence greater than a certain threshold indicate the presence of lane line key points at the corresponding positions in the image. Combining this with the offsets in the x and y directions, the accurate positions of the lane line points can be obtained. Then, the Euclidean distance of the embedding feature vectors of different lane line points is calculated for clustering, resulting in complete lane line instances. The rail key point detection results of the key point detection model are similar to those shown in FIG. 3.

After obtaining the key points of the rails in the left and right images, the key points are matched between the two images. This can be done by extracting feature descriptors at the pixel locations and then calculating the feature similarity of the rail key points for matching, or other matching methods can be used. For example, the SIFT feature matching method involves performing SIFT feature detection on images, extracting key points and their feature descriptors. Each key point's descriptor is a 128-dimensional vector representing the gradient distribution around that point. Then, the Euclidean distance between the feature points is calculated, and for each descriptor in the first image, the closest descriptor in the second image is found for matching. Other commonly used feature matching methods include SURF and ORB feature matching.

Further, in order to achieve above objectives, the present invention further provides a vision-guided drone-based subway inspection device, comprising a memory, a processor, and a vision-guided drone-based subway inspection program stored in the memory and executable on the processor, wherein when the vision-guided drone-based subway inspection program is executed by the processor, the steps of the vision-guided drone-based subway inspection method mentioned above are performed.

Further, in order to achieve above objectives, the present invention further provides a computer-readable storage medium storing a vision-guided drone-based subway inspection program, wherein when the vision-guided drone-based subway inspection program is executed by a processor, the steps of the vision-guided drone-based subway inspection method mentioned above are performed.

After obtaining matching results of the trajectory key points in the left and right images, the depth information of the trajectory key points in the images is calculated based on the camera's focal lengths and the disparities between the left and right images, and then transformed into real 3D space by using the intrinsic and extrinsic parameter matrices of the camera.

Since the rail gauge and the distance between consecutive sleepers can be measured in advance, this prior information can be used to correct the detection results of the model.

The main types of errors can be categorized as follows:
(1) Incorrect classification of rail key points.
(2) False detection of rail key points.
(3) Missed detection of rail key points.

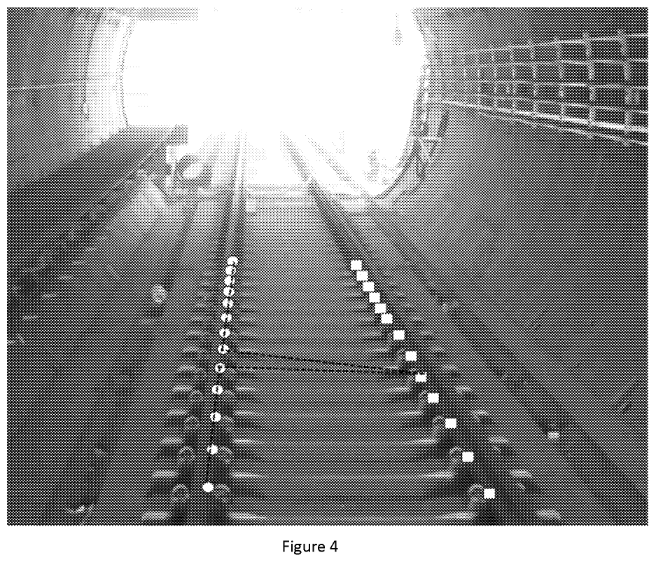

FIG. 4 shows an example of misclassification of key points on the rail. The red key points in the right rail are incorrectly classified.

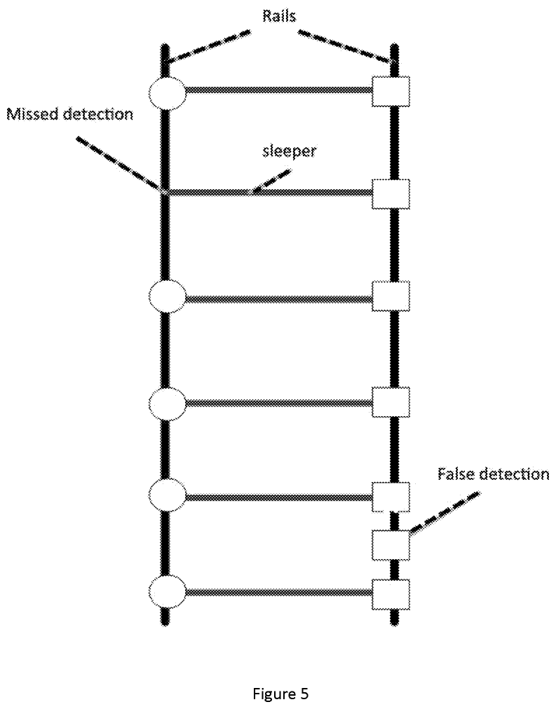

Similarly, as shown in FIG. 5, the slope change of the rail can be used to locate misclassified key points. If the slopes between adjacent points on the rails change, the classification is corrected. For false positives and false negatives of rail key points, we can determine them by checking whether the distance between adjacent key points exceeds the maximum sleeper spacing or is less than the minimum sleeper spacing threshold. False positives are removed, and false negatives are added.

After correcting the model's detection results based on prior information about the rail, the matching relationship between the key points of left rails and key points of right rails is obtained using the Hungarian matching method. Then, the midpoint of the matched key points on both sides of the rail is calculated to extract the reference path for the drone inspection.

Meanwhile, the complete trajectory points can be back-projected onto the image and added to the image feature points detected by the visual positioning algorithm to jointly calculate the drone's position information. The drone's position can be obtained through feature-based SLAM positioning algorithms similar to ORB-SLAM. To control the drone to follow the reference path, it is necessary to know not only the drone's current position but also its desired position at the current time, which is then fed into the controller.

Since the drone has a forward flight speed, directly using the point on the reference path closest to the drone as the desired position at the current time may lead to oscillations in the drone's flight trajectory. Instead, the drone should rail a point on the reference path ahead of its current position.

Therefore, this application rails the desired path using a look-ahead method, calculating the look-ahead distance based on the drone's takeoff altitude, current flight speed, and the curvature of the trajectory. Since the camera is mounted at a fixed angle facing downwards, the drone's takeoff altitude determines the upper and lower limits of the look-ahead distance.

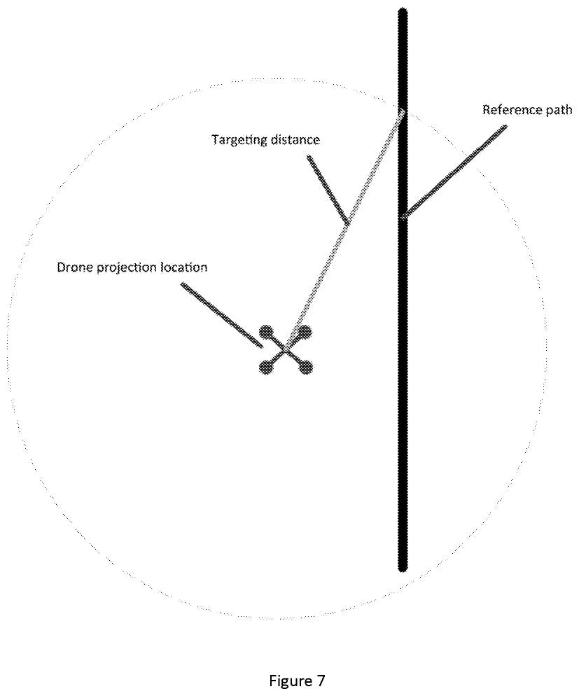

As shown in FIG. 7, the faster the drone's flight speed, the longer the look-ahead distance should be; otherwise, it will cause oscillations in the drone's flight path. If the road curvature radius is larger, indicating a greater degree of curvature, the look-ahead distance should be reduced to allow the drone to better rail the reference path for inspection. The calculated look-ahead distance should not exceed its upper and lower limits.

Then, the drone's altitude is ignored, and the drone is projected onto the rail plane. A circle is drawn with the projected position of the drone as the center and the pre-aiming distance as the radius. The intersection point of this circle with the reference path is calculated as the optimal desired position in the horizontal direction. The drone's current flight altitude is used as the vertical position coordinate, and this desired position information is sent to the controller.

In summary, this application can achieve fully automated inspection of subway tunnels using only a stereo camera sensor, significantly reducing costs. Key points of the rails on both sides are detected using a keypoint detection model in deep learning, and these points are matched in the left and right images to recover the coordinates of the rail key points in the real world. Prior information about the rail dimensions is used to post-process the algorithm's detection results, eliminating incorrect key points and adding missing key points, thus improving the accuracy of the algorithm model and obtaining a more accurate reference path. The optimized 3D rail key points are back-projected into the image and added to the image feature points detected by the visual positioning algorithm to jointly calculate the drone's current position. Because the number of accurately matched feature points is increased, the positioning accuracy of the drone is improved.

To ensure the drone accurately and smoothly rails the desired path, the expected position of the drone during inspection is calculated using a look-ahead method. The look-ahead distance is calculated based on the drone's current flight speed, flight altitude, and trajectory curvature information. By selecting the optimal desired position on the reference path, the drone can rail the reference path more smoothly and accurately during inspection. If an obstacle appears within the field of view, an obstacle avoidance algorithm is used for path planning to bypass the obstacle. When there are no obstacles within the field of view, the drone resumes railing the reference path, ensuring the safety of the drone during inspection.

In another embodiment, for projecting image trajectory key points onto 3D space, an RGB-D camera or a combination of radar and camera can be used, as knowledge of the depth information of the image trajectory key points is required. Both the depth camera in the RGB-D camera and the radar can measure this depth.

For drone positioning, other algorithms can be used. This proposal uses a stereo camera and runs an algorithm to determine the drone's position. Positioning can also be achieved using RGB-D cameras, radar, or other sensors.

This invention proposes a vision-guided drone-based subway inspection method. This method requires only a stereo camera sensor to achieve fully automated drone inspection, significantly reducing inspection costs. Furthermore, it eliminates the need to pre-build a subway tunnel model or mark inspection paths. The system can automatically identify and rail the inspection path online, making the inspection process more intelligent and convenient. By controlling the drone to fly above the rails, it can also effectively acquire environmental information within the subway tunnel.

By correcting the detection results of key rail points using prior information about the rails and sleepers, the accuracy of rail detection results is improved. Simultaneously, the corrected key rail points are projected back onto the images and added to the image feature points detected by the visual positioning algorithm, which jointly contribute to the drones' positioning and increases the number of feature points and improves the accuracy and stability of drone positioning.

Through a look-ahead method, the reference path is railed. The look-ahead distance is calculated based on the drone's flight speed and rail curvature. Then, the upper and lower bounds of the look-ahead distance are calculated based on the drone's takeoff altitude and camera mounting angle, and the look-ahead distance is constrained accordingly. Based on the constrained look-ahead distance, the optimal desired position on the reference path is found and transmitted to the controller. This enables the drone to smoothly and accurately rail the reference path for inspection.

Furthermore, embodiments of the present invention also provide a computer-readable storage medium storing a vision-guided drone-based subway inspection program. When executed by a processor, the vision-guided drone-based subway inspection program performs the following operations:
using a stereo camera to acquire images of rails, and marking data points on acquired images;
dividing the data points into key points of left rails and key points of right rails, and matching rail key points in left and right images;
obtaining matching results of trajectory key points from the left and right images, and calculating image depth information of the trajectory key points based on camera's focal lengths and disparities between the left and right images; and;
calculating midpoints of matched key points on both sides of the rails to extract reference paths for the drone inspection.

Furthermore, when executed by a processor, the vision-guided drone-based subway inspection program performs the following operations:
using prior information about rail dimensions to eliminate incorrectly detected key points and supplement missed key points, so that number of key points on left rails is equal to number of key points on right rails.

Furthermore, when executed by a processor, the vision-guided drone-based subway inspection program performs the following operations:
determining whether key points are incorrectly detected or missed by checking if distances between consecutive key points exceeds a maximum allowable distance or falls below a minimum allowable distance of sleepers.

Furthermore, when executed by a processor, the vision-guided drone-based subway inspection program performs the following operations:
transforming image data into real 3D space through camera's intrinsic and extrinsic matrices.

Furthermore, when executed by a processor, the vision-guided drone-based subway inspection program performs the following operations:
obtaining drone's desired positions on the reference paths at a current time, and guiding the drones to perform inspection along the reference paths at the desired positions.

Furthermore, when executed by a processor, the vision-guided drone-based subway inspection program performs the following operations:
projecting the drones onto a trajectory plane, drawing circles with projected positions of the drones as centers and look-ahead distances as the radiuses, and using intersection points with the reference paths as optimal desired positions in a horizontal direction, thereby guiding the drones to perform inspection along the optimal desired positions on the reference paths.

The specific embodiments of the computer-readable storage medium of the present invention are substantially the same as the embodiments of the above-described vision-guided drone subway inspection method, and therefore will not be described in detail here.

It should be noted that, in this document, the terms “comprising,” “including,” or any other variation thereof are intended to cover non-exclusive inclusion, such that a process, method, article, or system that comprises a list of elements not only includes those elements, but also includes other elements not explicitly listed, or elements inherent to such a process, method, article, or system. Without further limitation, an element defined by the phrase “comprising a . . . ” does not exclude the presence of other identical elements in the process, method, article, or system that includes that element.

The embodiment numbers of the present invention described above are for descriptive purposes only and do not represent the superiority or inferiority of the embodiments.

Based on the above description of the implementation methods, those skilled in the art can clearly understand that the methods of the above embodiments can be implemented by means of software combined with the necessary general-purpose hardware platform. Of course, it can also be implemented through hardware, but in many cases, the former is a better implementation method. Based on this understanding, the technical solution of the present invention, or the part that contributes to the prior art, can be embodied in the form of a software product. This computer software product is stored in a storage medium as described above (such as ROM/RAM, magnetic disk, optical disc), and includes several instructions to enable a terminal device (which can be a mobile phone, computer, server, air conditioner, or network device, etc.) to execute the methods described in the various embodiments of the present invention.

The above are only preferred embodiments of the present invention, and therefore do not limit the scope of the present invention. Any equivalent structural or process transformations made using the content of the specification and drawings of the present invention, or directly or indirectly applied to other related technical fields, are similarly included within the scope of patent protection of the present invention.

1. A vision-guided drone-based subway inspection method, comprising following steps of:
using a stereo camera to acquire images of rails, and marking data points on acquired images;
dividing the data points into key points of left rails and key points of right rails, and matching rail key points in left and right images;
obtaining matching results of trajectory key points from the left and right images, and calculating image depth information of the trajectory key points based on camera's focal lengths and disparities between the left and right images; and;
calculating midpoints of matched key points on both sides of the rails to extract reference paths for the drone inspection.

2. The vision-guided drone-based subway inspection method according to claim 1, wherein after the steps of using a stereo camera to acquire images of rails, and marking data points on acquired images, the vision-guided drone-based subway inspection method further comprises:
using prior information about rail dimensions to eliminate incorrectly detected key points and supplement missed key points, so that number of key points on left rails is equal to number of key points on right rails.

3. The vision-guided drone-based subway inspection method according to claim 2, wherein the steps of using prior information about rail dimensions to eliminate incorrectly detected key points and supplement missed key points specifically comprises:
determining whether key points are incorrectly detected or missed by checking if distances between consecutive key points exceeds a maximum allowable distance or falls below a minimum allowable distance of sleepers.

4. The vision-guided drone-based subway inspection method according to claim 2, wherein after the steps of obtaining matching results of trajectory key points from the left and right images, and calculating image depth information of the trajectory key points based on camera's focal lengths and disparities between the left and right images, the vision-guided drone-based subway inspection method further comprises:
transforming image data into real 3D space through camera's intrinsic and extrinsic matrices.

5. The vision-guided drone-based subway inspection method according to claim 1, wherein after the steps of calculating midpoints of matched key points on both sides of the rails to extract reference paths for the drone inspection, the vision-guided drone-based subway inspection method further comprises:
obtaining drone's desired positions on the reference paths at a current time, and guiding the drones to perform inspection along the reference paths at the desired positions.

6. The vision-guided drone-based subway inspection method according to claim 5, wherein the steps of obtaining drone's desired positions on the reference paths at a current time, and guiding the drones to perform inspection along the reference paths at the desired positions, comprise:
projecting the drones onto a trajectory plane, drawing circles with projected positions of the drones as centers and look-ahead distances as the radiuses, and using intersection points with the reference paths as optimal desired positions in a horizontal direction, thereby guiding the drones to perform inspection along the optimal desired positions on the reference paths.

7. A vision-guided drone-based subway inspection device, comprising a memory, a processor, and a vision-guided drone-based subway inspection program stored in the memory and executable on the processor, wherein when the vision-guided drone-based subway inspection program is executed by the processor, the steps of the vision-guided drone-based subway inspection method according to claim 1 are performed.

8. A computer-readable storage medium storing a vision-guided drone-based subway inspection program, wherein when the vision-guided drone-based subway inspection program is executed by a processor, the steps of the vision-guided drone-based subway inspection method according to claim 1 are performed.
